(19) United States
(12) Patent Application Publication
(10) Pub. No.: US 2026/0058592 A1
(43) Pub. Date: Feb. 26, 2026

(54) CONTROL SYSTEM FOR A MULTIPHASE BRUSHLESS MOTOR WITHOUT A POSITION SENSOR

(71) Applicant: Sonceboz Motion Boncourt SA, Boncourt (CN)

(72) Inventor: Christophe Audouy, Sonceboz-Sombeval (CH)

(21) Appl. No.: 19/104,835

(22) PCT Filed: Aug. 25, 2023
(86) PCT No.: PCT/EP2023/073444

§ 371 Date: Feb. 19, 2025

(30) Foreign Application Priority Data
Aug. 25, 2022 (FR) FR2208518

(51) Int. Cl. H02P 29/032; H02P 6/08; H02P 6/182; H02P 29/024

(52) U.S. Cl. CPC H02P 29/032; H02P 6/085; H02P 6/182; H02P 29/024

(57) ABSTRACT

A control system for a multiphase brushless motor without a position sensor, incorporating drive control electronics, comprising: a switching means, provided with two-state switches for varying the electrical voltage applied to each of the phases; a means for detecting overloading of the motor; and a means for determining an operating point, allowing at least two operating points to be applied, the control electronics being arranged to use space vector modulation or vector modulation to generate a sinusoidal waveform from a DC voltage, and the control electronics being arranged to modify the operating point at least once if an overload is detected by the overload detection means.

### CROSS-REFERENCE TO RELATED APPLICATIONS

This application is a national phase entry under 35 U.S.C. § 371 of International Patent Application PCT/EP2023/073444, filed Aug. 25, 2023, designating the United States of America and published as International Patent Publication WO 2024/042241 A1 on Feb. 29, 2024, which claims the benefit under Article 8 of the Patent Cooperation Treaty of French Patent Application Serial No. FR2208518, filed Aug. 25, 2022.

### TECHNICAL FIELD

The present disclosure relates to the field of stepping motor gearboxes (multiphase synchronous brushless DC motors controlled in a stepper mode) and, more particularly, to geared motors controlled in a microstepping mode.

### BACKGROUND

The stepper control mode leads to rotor rotation increments called full steps, which correspond, for example, to six full steps (respectively, four) per electrical period of the current present in each phase, for a three-phase (respectively two-phase) motor. To reduce this rotation increment, for example, in order to reduce operating noise and rotor vibration, the full steps can be subdivided into microsteps. To achieve this, and in contrast to the full-step control mode, each motor phase must then be controlled with a current of substantially sinusoidal form as a function of the number of microsteps per step. For a three-phase motor, six transistors are needed to simultaneously impose three substantially sinusoidal current waves, phase-shifted by 120°, on the three phases of the motor.

The usual methods for detecting lock or stall in stepper motor gearboxes use means for detecting the value of the voltage induced in the motor phases, in particular states of the transistors controlling these phases (open state, for example, enabling the voltage induced in the unused phase to be measured without interference).

Therefore, with multiphase motors controlled in microstepping mode and using all the power transistors simultaneously, it is difficult to access this induced voltage measurement.

In the prior art, U.S. Patent Application Publication No. US2017126153 is known, which describes a method for detecting a locked rotor condition in a sensorless permanent magnet synchronous motor, comprising:
determining an estimated rotor speed and a first back EMF voltage value, BEMF, in an estimated rotor-related reference frame using a BEMF observer;
calculating a second estimated BEMF voltage value in a rotor-related reference frame based on at least a first motor constant and the estimated rotor speed
generating a BEMF error filter value (BEMFErrorFilt) based on a difference between the first and second estimated BEMF voltage values;
generating a BEMF error threshold value (BEMFErrorThreshold) as a function of the estimated rotor speed (ω) subject to a minimum threshold BEMF value (BEMFErrorThresholdMin); and
detecting a rotor lock condition in the sensorless permanent magnet synchronous motor based on at least the BEMF error filter value (BEMFErrorFilt) and the BEMF error threshold value (BEMFErrorThreshold).

Also known is European Patent Application EP3826170, which describes a stall detector for detecting the stall of a brushless DC motor. The brushless DC motor is adapted for applying one or more driving signals such that currents through the one or more coils of the brushless DC motor are generating a flux for driving the motor. The stall detector comprises a processing device adapted to determine a direct angle between a back EMF voltage vector generated by the motor and a current vector representing the flux generated by currents through one or more coils. The processing device is further adapted to determine that the motor is stalling when the direct angle exceeds a predefined threshold at least once.

European Patent EP2966772 provides a method of detecting stall of a two-phase or three-phase motor operated in a micro-stepped mode, the method comprising:
a) applying a plurality of phase-shifted micro-stepped waveforms to the phase windings (Lu, Lv, Lw) of the motor, whereby the phase-shift is about 120° in case of a three-phase motor and about 90° in case of a two-phase motor;
b) determining a sum of currents flowing through the phase windings of the motor, and taking samples (Raw) of the sum of currents synchronously with the application of the micro-stepped waveforms;
c) calculating a moving average (MovAvg) or a moving sum of the samples over a number of samples corresponding to 120° or an even multiple of 60° of the micro-stepped waveform in case of a three-phase motor and corresponding to 180° or an even multiple of 90° of the micro-stepped waveform in case of a two-phase motor;
d) calculating an adaptive threshold based on the samples (Raw);
e) detecting stall of the motor when the moving average (MovAvg) or moving sum is larger than the adaptive threshold.

Japanese Patent Application JP2005151678 offers a device for sensorless control of a damperless permanent-magnet synchronous motor (PM motor).

Some of the prior art solutions require one or more position or torque sensors, which increases manufacturing cost and complexity.

Other solutions require complex algorithmic processing, involving the use of powerful processors and high-power consumption.

Finally, these solutions lead to untimely stoppages when the resistance to movement of the driven member increases and exceeds a resistance torque despite not being counted as a lock. This leads to inappropriate positioning, and possibly inappropriate error reporting.

### BRIEF SUMMARY

The object of the present disclosure is to remedy this disadvantage and relates, according to its most general acceptance, to a control system for a multiphase brushless motor.

The motor has no position sensor and incorporates drive control electronics comprising:
switching means, with two-state switches, for varying the voltage applied to each phase,
means for detecting overloading of the motor,
means for determining an operating point, enabling at least two operating points to be applied, and
the control electronics being arranged to use space vector modulation to generate a sinusoidal waveform from a DC voltage.

The control electronics are arranged to modify the operating point at least once in the event of an overload being detected by the overload detection means.

Advantageously, the stall detection means comprises a circuit for measuring the total current consumed by the motor's N phases.

In one embodiment, the stall detection means comprises a sampling resistor and means for measuring in the resistor the image of the total current drawn in the sum of the N phases of the multiphase motor.

In another embodiment, the stall detection means comprises:
means for measuring the sum of currents flowing in each motor phase,
means for calculating a stop detection threshold in relation to the evolution of the sum of the currents, and
means for processing the sampled current values by a mathematical or statistical operation, the stop detection threshold being determined with reference to the result of this processing.

Advantageously, the overload detection means delivers a signal commanding the modification of the operating point in the event of overload detection during X consecutive iterations, then a motor stop instruction in the event of a new stall detection.

In addition, the means for determining an operating point comprises an interface for receiving a signal from an external condition sensor.

For example, the external condition sensor is a temperature sensor.

Alternatively, the external condition sensor provides a measurement of the supply voltage to the switching means.

### BRIEF DESCRIPTION OF THE DRAWINGS

Further advantages of the present disclosure will be readily appreciated, as these become better understood with reference to the following detailed description shown by the appended drawings wherein:

FIG. 1 is a schematic view of the control circuit for driving a three-phase BLDC motor;

FIG. 2 is a schematic view of the “space vector modulation” processing circuit for driving a three-phase BLDC motor;

FIG. 3 are timing diagrams of the signals used to implement the disclosure;

FIG. 4 are timing diagrams of two types of operating points; and

FIG. 5 is an example of a motion start sequence with the operating point being updated when an overload is detected.

### DETAILED DESCRIPTION

The proposed solution consists of implementing a space vector modulation (SVM) control mode, whose operating points can be adapted according to the external load and/or external conditions (e.g., temperature/voltage).

The principle of the disclosure consists in providing control electronics arranged to detect an overload by the overload detection means (32) and, in the event of detection of an overload, to modify the operating point at least once
by increasing current and/or voltage,
and/or reducing the speed setpoint, and
in the event of continued overload detection (32) at the end of a cycle of N iterations, to command the motor to stop, N being greater than 1, in order to avoid constantly calculating the new setpoint via the application of Clarke and Park transforms that require heavy digital processing.

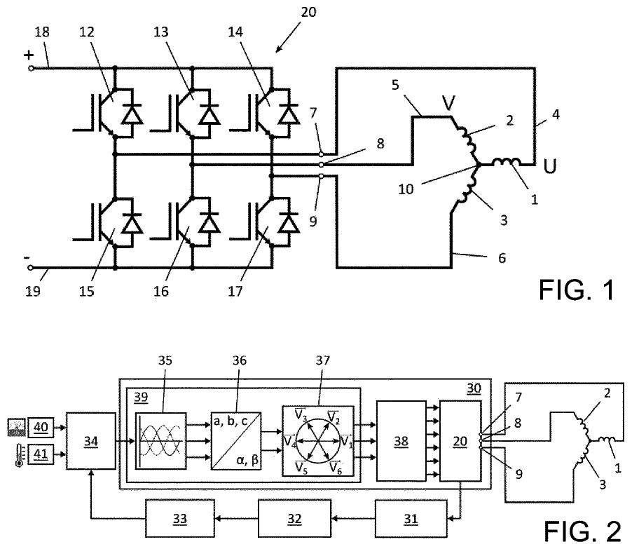

The general principle of a control circuit for driving a star-connected three-phase BLDC motor is shown in FIG. 1. A three-phase brushless DC motor consists of three motor windings (1 to 3), designated as phases U, V, W, connected in a star network. One end (4 to 6) of each winding (1 to 3) is connected to a termination (7 to 9) respectively. The other ends of the windings (1 to 3) are connected together by a termination (10) to form a star connection. The control circuit comprises a switching means (20), in this case a three-phase bridge. Each arm of the three-phase bridge comprises a pair of switches (12 to 17) in the form of an upper and a lower transistor connected in series between a supply rail (18) and the ground line (19). The terminations (7, 8, 9) are electrically connected to the three-phase bridge, respectively between a complementary pair of switches (12, 15; 13, 16; 14, 17). The switches (12 to 17) are switched on and off in a controlled manner by a controller to provide pulse-width modulation of the potential applied to each of the terminations (7 to 9), in order to control the potential difference applied across each of the windings (1 to 3) and hence also the current flowing through the windings (1 to 3) and consequently the strength and orientation of the magnetic field produced by the windings (1 to 3).

Note that FIG. 1 shows a three-phase bridge connected to a star-connected three-phase winding. However, this configuration is not limitative of the disclosure, and any other number of phases, or winding connection, known to the person skilled in the art is conceivable. For example, a motor with twelve coils connected in parallel delta, each winding comprising four coils connected in parallel, is included in the disclosure. It is also possible to use a full-bridge inverter, with two times as many arms, where each winding end is connected to an inverter arm. The use of multi-level inverters, with more than two switches per arm, is not excluded either.

### Detailed Description of the “Space Vector Modulation” Control Circuit

FIG. 2 shows a schematic view of the “space vector modulation” processing circuit for driving a three-phase BLDC motor according to the disclosure.

The SVM control is generated via the subassembly (30). For this operation, a pre-programmed vector table can be used for subassembly (37), which does not require significant computing power by bypassing the conventional sinusoidal signal generators in subassembly (35) and the transformation in the a, B plane performed by subassembly (36). The subassembly (38) generates setpoint signals to the switching means (20) in the form of a PWM command. Subassemblies (35) to (37) can be combined into a single subassembly (39) via a pre-programmed vector switching table.

SVM control is a principle well known to the person skilled in the art and makes it possible to generate a sinusoidal phase current from a DC supply voltage by controlling the activation time of each branch of the inverter. The feedback loop is made up of multiple sub-assemblies, including current measurement means (31), overload detection means (32), and setpoint signal correction means (33). This feedback loop is traditionally formed by sensors or complex algorithms requiring the use of Clarke and Park transformations. A phase current/voltage measurement is made through the sub-assembly (31), and this data can be used by an overload detection means (32), for example, a stall detection algorithm. Depending on the output signal of the overload detection algorithm, the setpoint signal correction means (33) for current and/or speed transmits the appropriate signal to the means for determining an operating point (34). The means for determining an operating point (34) compiles all the data from the feedback loop and possibly from external condition sensors (40, 41), for example, temperature or inverter supply voltage, in order to select the optimum operating point to apply to the system.

### Description of the Operating Point Change Algorithm

The operating principle of the algorithm is to dynamically adapt the operating point according to the detection of an overload, and optionally, according to external condition data such as temperature, voltage, load, or any other parameter or combination of these.

This mode of operation avoids the need for computationally intensive digital processing of a Clarke and Park transform, while approximating behavior similar to the FOC (Field Oriented Control) mode.

To achieve this, a stall detection algorithm is implemented to stop the motor before it stalls in the event of a large external load, so that a new operating point can be used. This algorithm can be, for example, the algorithm described in patent EP1680862 or any other stall detection algorithm.

The stall detection algorithm is normally implemented to stop the motor before it stalls in the event of a heavy external load. The disclosure consists in not systematically commanding the motor to stop, but in transiently using this information to command a modification of the operating point, possibly in an increasing sequence, before actually commanding the motor to stop.

To this end, the microcontroller decides before reporting the stall to restart a movement with an operating point that offers more torque (by reducing speed and/or increasing current), after a predefined time or movement, it may be envisaged to return to the initial operating point.

If the second operating point is not sufficient, it is then possible to inform the user (via the ECU in the automotive sector) that the actuator is stalled, or to retry the movement with another operating point.

Depending on the responsiveness of the stop detection algorithm, one can choose whether or not to stop the motor for the operating point change.

It is also possible to use external conditions to evaluate the operating point to be applied to the motor. This check of external conditions can be carried out before starting the movement or during the movement.

Example: The actuator is able to deliver a dynamic torque of 1.5 Nm at 4 rpm over the entire temperature range, but only if the voltage is between 11 and 16 V. If the measured voltage is between 9 V and 11 V, the actuator decides to reduce speed to 2.25 rpm to guarantee a torque of 1.5 Nm.

### Operating Example

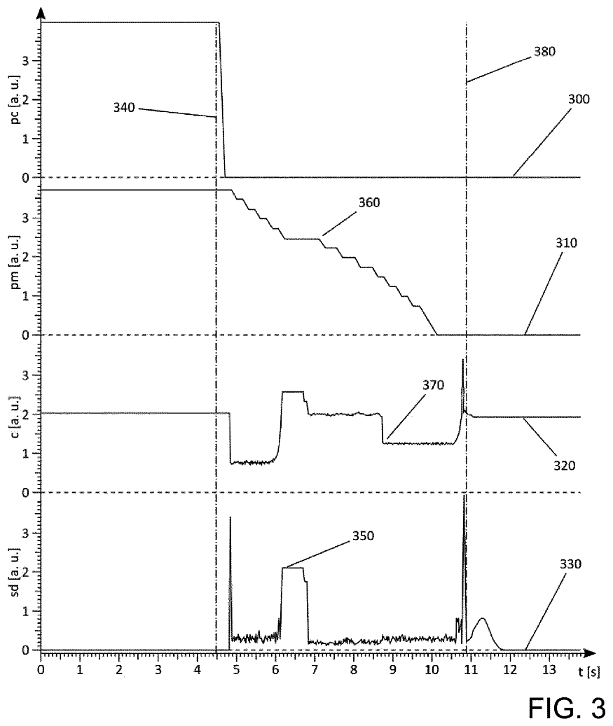

FIG. 3 shows the timing diagram of the position command, position feedback, current, and stall detection signals. The position command, pc, is shown by the curve (300), the position feedback, pm, is shown by the curve (310), the current measurement, c, is shown by the curve (320), the stall detection algorithm measurement, sd, is shown by the curve (330). All curves are represented in arbitrary units, a.u.

During this sequence, a closure command (340) is transmitted to the actuator. During this closing movement, the actuator detects a stall (350).

A change of operating point, e.g., by reducing speed, is then carried out without any error being sent back to the ECU. This new operating point (360) allows the movement to continue and resolves the stall condition detected by the algorithm. Once the sticking point has been passed, another operating point (370) can be set to complete the movement until the controlled member reaches the known stop position, at the time (380). As the final position is known, the algorithm does not adapt the operating point but simply stops the movement.

### Example of Point Adaptation in Operation

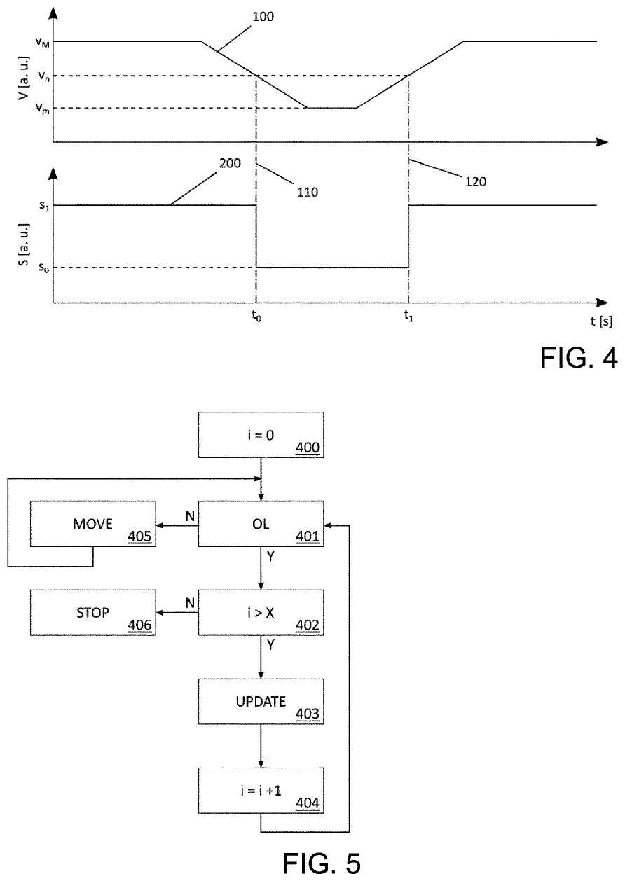

FIG. 4 shows the timing diagram showing operating point adaptation as a function of inverter supply voltage. The curve (100) shows the change in inverter supply voltage, v, and the curve (200) shows the change in setpoint speed, s.

When the device is in use, the member connected to the actuator is driven at a nominal speed s=s₁. The inverter's supply voltage, now v=v_{M}, gives a nominal torque T₁. If, for any reason, the supply voltage drops below the threshold voltage v=vₙ at time (110) t=t₀. The voltage at the inverter terminals is then no longer sufficient to obtain the rated torque T₁. The operating point can then be adapted, for example, by lowering the speed s to a value s=s₀ enabling the rated torque T₁ to be obtained for a voltage greater than v=vₘ. If, at time (120) t=t₁, the voltage rises above the threshold value v=vₙ, again, the speed is adapted back to its nominal value s=s₁. If, during movement, the voltage falls below the threshold v=vₘ, the speed is adapted again to ensure that the nominal torque T₁ is achieved. If the voltage drops so that the nominal torque can no longer be achieved, the algorithm may decide to stop the movement.

### Example of an Operating Point Adaptation Algorithm

In this context, FIG. 5 shows an example of a motion start sequence with the operating point being updated when an overload is detected.

When motion is started, the algorithm leaves the initialization block (400) to perform an overload check, alternating the overload detection monitoring block OL (401) and the motion block MOVE (405) via a loop. In the event of overload, the algorithm leaves the loop to modify the operating point. The algorithm then joins the block (402) controlling the value of the incremental variable i and, if the threshold X is not exceeded, proceeds to update the operating point in an attempt to pass this blockage, without stopping motion, via the UPDATE block (403) before proceeding to increment the variable i described by the block (404) before returning to the loop monitoring the overload. If the overload condition persists, the algorithm attempts a further incrementing of the operating point, up to a limit of X attempts. If the overload persists after X operating point updates, the algorithm joins the block STOP (406) and the motor is stopped.

This sequence is by no means limitative of the disclosure, and the person skilled in the art could imagine other possibilities depending on the goal to be achieved. For example, it is possible to imagine a sequence where the operating point is not gradually increased to provide more torque but follows a dichotomous adjustment to optimize the final value.

1. A control system for a multiphase brushless motor without a position sensor, incorporating drive control electronics, comprising:
switching means with two-state switches for varying voltage applied to each of the phases of the motor;
means for detecting overloading of the motor;
means for determining an operating point, enabling at least two operating points to be applied;
wherein the drive control electronics is arranged to modify, in the event of detection of an overload by the overload detection means, the operating point at least once, the overload detection means delivering a signal controlling the modification of the operating point in the event of detection of overload during a plurality of consecutive iterations, then an instruction to stop the motor in the event of a new stall detection.

2. The control system of claim 1, wherein the drive control electronics is arranged to use space vector modulation to generate a sinusoidal waveform from a DC voltage.

3. The control system of claim 1, wherein the overload detection means comprises a circuit for measuring a total current consumed by N phases of the motor.

4. The control system of claim 1, wherein the overload detection means comprises a sampling resistor and means for measuring in the sampling resistor an image of a total current drawn in a sum of the N phases of the motor.

5. The control system of claim 1, wherein the overload detection means comprises:
means for measuring a sum of currents flowing in each of the phases of the motor;
means for calculating a stop detection threshold in relation to evolution of the sum of the currents; and
means for processing sampled current values by a mathematical or statistical operation, the stop detection threshold being determined with reference to a result of this processing.

6. The control system of claim 1, wherein the means for determining an operating point comprises an interface for receiving a signal supplied by an external condition sensor.

7. The control system of claim 6, wherein the external condition sensor is a temperature sensor.

8. The control system of claim 6, wherein the external condition sensor provides a measure of a supply voltage to the switching means.

9. A multiphase brushless motor, comprising:
two or more motor windings each corresponding to a phase of the motor;
a rotor configured to rotate responsive to magnetic fields produced by the two or more motor windings; and
a control system for controlling the motor, including:
switching means with two-state switches for varying voltage applied to each of the two or more windings;
means for detecting overloading of the motor; and
means for determining an operating point, enabling at least two operating points to be applied;
wherein the control system is configured to modify the operating point at least once if an overload is detected by the overload detection means, the overload detection means delivering a signal controlling the modification of the operating point in the event of detection of overload during a plurality of consecutive iterations, the control system configured to then stop the motor if another overload is later detected by the overload detection means; and
wherein the motor does not include a position sensor.

10. The motor of claim 9, wherein the drive control electronics is arranged to use space vector modulation to generate a sinusoidal waveform from a DC voltage.

11. The motor of claim 9, wherein the overload detection means comprises a circuit for measuring a total current consumed by N phases of the motor.

12. The motor of claim 9, wherein the overload detection means comprises a sampling resistor and means for measuring in the sampling resistor an image of a total current drawn in a sum of the phases of the motor.

13. The motor of claim 9, wherein the overload detection means comprises:
means for measuring a sum of currents flowing in each of the phases of the motor;
means for calculating a stop detection threshold in relation to evolution of the sum of the currents; and
means for processing sampled current values by a mathematical or statistical operation, the stop detection threshold being determined with reference to a result of this processing.

14. The motor of claim 13, wherein the means for determining an operating point comprises an interface for receiving a signal supplied by an external condition sensor.

15. The motor of claim 14, wherein the external condition sensor is a temperature sensor.

16. The motor of claim 14, wherein the external condition sensor provides a measure of a supply voltage to the switching means.
